(19) United States
(12) Patent Application Publication
(10) Pub. No.: US 2022/0371306 A1
(43) Pub. Date: Nov. 24, 2022

(54) LAMINATED GLAZING HAVING AN ULTRAVIOLET LIGHT SHIELDING COATING

(71) Applicant: ACR II GLASS AMERICA INC., Nashville, TN (US)

(72) Inventors: Markus Walter Pohlen, Mückeln (DE); Steven Scott Christman, Nashville, TN (US); Emily Anne Curtis, Nashville, TN (US); Yu Matsuda, Nashville, TN (US)

(73) Assignee: ACR II GLASS AMERICA INC., Nashville, TN (US)

(21) Appl. No.: 17/774,505

(22) PCT Filed: Nov. 2, 2020
(86) PCT No.: PCT/US2020/058525

§ 371 Date: May 5, 2022

Related U.S. Application Data
(60) Provisional application No. 62/930,627, filed on Nov. 5, 2019.

(51) Int. Cl. B32B 17/10; B32B 7/12

(52) U.S. Cl. CPC B32B 17/10706; B32B 17/10036; B32B 17/10247; B32B 17/10449; B32B 17/10834; B32B 17/1099; B32B 17/10761; B32B 17/10788; B32B 7/12; B32B 17/10678; B32B 2255/20; B32B 2307/412; B32B 2605/006

(57) ABSTRACT

A disclosed laminated glazing comprises a first glass sheet, a first interlayer, a holographic film, a second interlayer having a light transmission of at least 70% at a light wavelength in the range of 250 nm to 400 nm, a second glass sheet, and an ultraviolet light absorbing coating and a method of making such a laminated glazing.

### CROSS REFERENCE TO RELATED APPLICATION

This application claims priority to U.S. Provisional Application No. 62/930,627 filed on Nov. 5, 2019, entitled “LAMINATED GLAZING HAVING AN ULTRAVIOLET LIGHT SHIELDING COATING,” the entire contents of which are incorporated by reference herein in their entirety.

### TECHNICAL FIELD

The present disclosure generally relates to laminated glazings having an ultraviolet light shielding coating thereon.

### BACKGROUND

Head-up displays (HUDs) are used in vehicles to project an image which a driver may see without looking away from the vehicle windshield. Particularly, HUD typically include a projector and reflect a projected image on a windshield to provide an image for a driver. However, a windshield has two reflective surfaces in the inner and outer glass surfaces which may each create a reflected image. One of the reflected images may be weaker and is known as a “ghost image” which may lead to the driver perceiving a hazy or double image.

Wedge-shaped interlayers have been used to align the images by adjusting the reflective point of the “ghost image” to match the reflection of the stronger image, creating a single image for the driver. However, a wedge-shaped interlayer is not adjustable and the images may be aligned only for drivers at a particular height. There is a need in the art for windshields having HUD capabilities for drivers with a range of heights.

One possible solution is to use a p-polarized projector and a laminated film which reflects p-polarized light. Being near the Brewster angle, the glass surface reflections will not generate ghost images. Another possible solution is to use a p- or s-polarized projector and a laminated film comprising a halfwave retarder. Being near Brewster angle, depending on the projector light polarization, only the inner or outer glass surface may reflect light. Laminating a film however may have the problem of wrinkles or short range deviations of the reflecting film surface which cause distortions in the HUD image.

There is a desire for HUD systems with larger HUD images which would need large projector apertures which are limited by available space in the vehicle dashboard. By using a holographic film which has focusing power (i.e. concave mirror feature), smaller projector sizes can be used.

A HUD construction may include a holographic film which provides a projected image to the driver. The holographic film may be laminated to or in a glazing, as described in Manfred-Andreas Beeck et al., Holographic mirrors laminated into windshields for automotive Head-Up Display and solar protective glazing applications, 1507 Proc. SPIE 394 (1991). However, laminating the film may cause particular difficulties, such as placement and curvature of the holographic film, as well as wrinkles or small scale deviations or unevenness in the film. There is a need in the art for a solution to at least these difficulties, among others.

One method of recording the holographic film may be commonly executed in two steps. First, a master hologram is generated by recording an interference pattern in a thin film of photosensitive polymer. Second, this master hologram is replicated in the hologram films as described in Friedrich-Karl Bruder, et al., Mass Production of Volume Holographic Optical Elements (vHOEs) using Bayfol® HX Photopolymer Film in a Roll-to-Roll Copy Process, 10127 Proc. SPIE 101270A (2017). Where these holographic films are laminated in the glazing, deviations resulting from lamination may be visible in a HUD image.

### SUMMARY OF THE DISCLOSURE

Disclosed herein is a laminated glazing, comprising: a first glass sheet; a first interlayer, a holographic film; a second interlayer; a second glass sheet; and an ultraviolet light absorbing coating.

In another aspect, disclosed is a method of preparing a laminated glazing, comprising: laminating a first glass sheet, a first interlayer, a photopolymer film, a second interlayer, and a second glass sheet; recording the photopolymer film to provide a holographic film; bleaching the holographic film with a bleaching light; and applying an ultraviolet light absorbing coating to a surface of the first or second glass sheet.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a cross section view of a laminated glazing, according to an exemplary embodiment of the present disclosure.

FIG. 2 illustrates an exemplary method of preparing a laminated glazing, according to the present disclosure.

### DETAILED DESCRIPTION

Disclosed herein are exemplary aspects of a laminated glazing having an ultraviolet light absorbing coating thereon. In the following description, for purposes of explanation, specific details are set forth in order to promote a thorough understanding of one or more aspects of the disclosure. It may be evident in some or all instances, however, that many aspects described below can be practiced without adopting the specific design details described below.

Typically, a laminated glazing may include a first glass sheet, a second glass sheet, and an interlayer laminated therebetween. The glass sheets may include, without limitation, soda-lime silicate glass described by ISO 16293-1:2008. For various applications, such as a vehicle windshield, the glass sheets may be bent prior to lamination. Preferably, the glass sheets may be bent with heat treatment from 560° C. to 700° C., more preferably from 580° C. to 660° C.

An interlayer may be any suitable material, including a polymer adhesive material, such as polyvinyl butyral (PVB), ethylene vinyl acetate (EVA), or an ionomer. The interlayer may be stacked between the first and second glass sheets and deaired prior to autoclaving. Deairing may include mechanical and/or vacuum pressure to remove air from between the glass sheets. Deairing processes may include any suitable means, such as press rollers, a vacuum ring or a vacuum bag. Vacuum bag deairing may include placing the stack of glass sheets and an interlayer in a vacuum bag and applying vacuum pressure to the system. The materials may be autoclaved, including heat and pressure, to provide a laminated glazing.

Laminated glazings having a film laminated therein may particularly be formed by laminating a first glass sheet, a first interlayer, a film, a second interlayer, and a second glass sheet. In some embodiments, the first and or second interlayers may be an adhesive layer which may be formed on a glass sheet or the laminated film. Laminated films may be particularly useful for a HUD compatible glazing, including, for example, a holographic film which may be used in combination with a projector to provide an image viewable to a driver. Holographic films may be further used in other applications, such as lighting introduction to and/or extraction from a glazing or as anisotropic transmissive elements for solar protection. Laminated glazings may have any suitable application, including those for a vehicle, such as a windshield, sunroof, back window, or side window. Laminated glazings, including those with a film laminated therein, may have a desired curvature for the glazing application.

In some laminated glazings, a laminated film may have small scale deviations or unevenness in the film. The deviations may be visible as light transmitting through the glazing is scattered by a changing angle and displacement of the film. The curvature of a glazing and the lamination process may contribute to the formation of such film properties as the film takes the shape of the glazing during lamination. Where a laminated film, such as a holographic film, is used for HUD, the deviations may be visible in the virtual HUD image diffracted by the holographic film.

A holographic film which may be laminated in a glazing for HUD applications may be prepared by a replication process. Typical replication processes may include positioning a master holographic film to a photopolymer film and applying a reactive light to the photopolymer film through the master holographic film. Where the replication is completed prior to lamination, the photopolymer film may be flat or substantially flat during replication. During lamination, the replicated photopolymer film may form deviations or other changes in the film structure which may locally wrinkle or otherwise alter the film structure. Further, high temperature and pressure during the autoclaving process may alter the Bragg grating in the hologram resulting in deviations in the designed hologram features as reflected wavelengths and angles. It may be preferable to replicate holographic film in a laminated glazing such that the replication is performed over any deviations in the already laminated photopolymer film.

Moreover, the holographic film which may be laminated in a glazing for HUD applications may be prepared by a beam recordation process. Typical beam recordation processes may include applying a light beam to a photopolymer film of the laminate glazing, resulting in the formation of the hologram within the recorded photopolymer film. The light beam can be a laser light beam, emitting coherent and monochromatic laser light when recording the hologram.

The photopolymer may be made from any suitable material capable of recording holograms or particularly, volume holographic optical elements (VOEs), by optical polymerization of monomers and oligomers. A photopolymer may include polymerizing monomers, photopolymerization initiators, and matrix polymers. Polymerizing monomers may include at least one of functional (meth) acrylate, functional (meth) acrylamide, functional (meth) acrylonitrile, and functional (meth) acrylic acid. Generally known photopolymerization initiators may be used without any material limitation and, for example, may include monomolecular initiators bimolecular initiators. Monomolecular initiators may include, for example, triazine, benzophenone, benzoin, and benzyl ketal. Matrix polymers may include, for example, polyurethanes, polyacrylates, and polymethylmethacrylates. A photopolymer used herein may include, for example, Bayfol (Registered trademark) IX made of Covestro LCC.

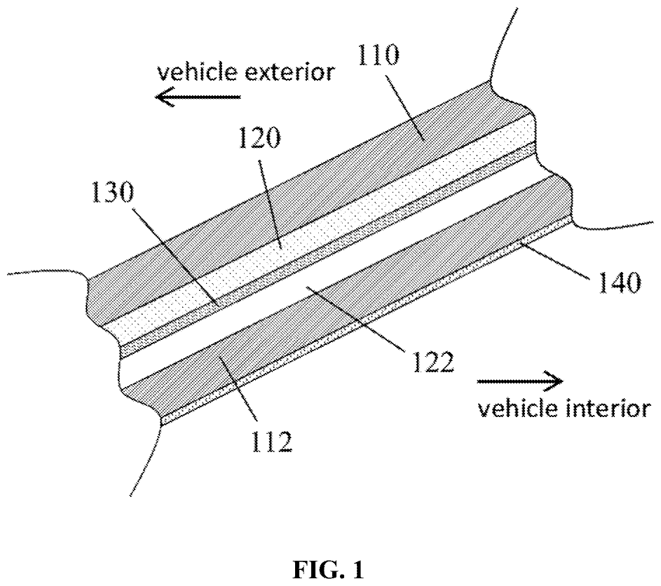

To provide a laminated holographic film which may not display deviations of the film in a diffracted image, the holographic film may be recorded in a laminated glazing. As shown in FIG. 1, particularly, a photopolymer film 130 may be laminated between at least two sheets 110, 112, such as glass sheets. Such a laminated construction may include a first glass sheet 110, a first interlayer 120, a photopolymer film 130, a second interlayer 122, and a second glass sheet 112. The photopolymer film 130 within the glazing may be treated with a light and a master holographic film after lamination such that the photopolymer film 130 may be recorded to provide a holographic film based on the master holographic film. Particularly, the master holographic film may be aligned with the photopolymer film 130 during recordation, at least in a region for IUD use in the laminated glazing. The master holographic film may have the same or substantially the same shape as the laminated glazing and may be positioned on a support having the same shape as the laminated glazing.

Once the master holographic film is aligned with the laminated glazing, a light to which the photopolymer film 130 is reactive may be applied to the photopolymer film 130 through the master holographic film. Particularly, a master film support may be transparent to the reactive light used during recordation. The process of forming the holographic film may further include, after the photopolymer film 130 is treated with the reactive light, treating the glazing, including the photopolymer film 130, with a bleaching light such that the photopolymer film 130 is no longer reactive to the reactive light. In some embodiments, the reactive light may have a wavelength in the range of 200 nm to 780 nm, more preferably 300 nm to 700 nm, and even more preferably from 380 nm to 680 nm. The reactive light has a wavelength different from that of the bleaching light. At least one of the reactive light and the bleaching light may preferably include light having a wavelength in an ultraviolet light wavelength range of from 250 nm to 400 nm.

During formation of the holographic film, including recordation and bleaching, the reactive light and bleaching light may pass through a glass sheet 112 and an interlayer 122 to reach a laminated photopolymer film 130. The glass sheet 112 and interlayer 122 may be transparent to the reactive light and the bleaching light such that the light treatments may reach the laminated photopolymer film 130. Typically, an interlayer may include light absorbing additives which may absorb certain light wavelengths, particularly in an ultraviolet light range. Ultraviolet light absorbing particles may be included in an interlayer to protect an interior space from ultraviolet light exposure and to protect the interlayer materials from damage that may be caused by ultraviolet light exposure. A laminated glazing for recordation of a laminated photopolymer film 130 may preferably include one interlayer having ultraviolet light absorbers and one interlayer which excludes ultraviolet light absorbers which are effective in a light wavelength of the reactive light and of the bleaching light. Preferably an interlayer 122 between the photopolymer film 130 and a vehicle interior, when the glazing is installed in a vehicle, may be transparent to the reactive light and the bleaching light such that an outer facing interlayer 120 may provide ultraviolet light protection when installed in a vehicle. It may be preferable that the interlayer 120 in the laminated glazing has a light transmission at a wavelength of the reactive light of less than 10%, more preferably less than 5%, and even more preferably less than 1%. It may be preferable that the interlayer 122 in the laminated glazing has a light transmission at a wavelength of the reactive light of at least 70%, more preferably at least 80%, and even more preferably at least 90%. Light transmittance may be determined according to ISO 9050: 2003, “Glass in building—Determination of light transmittance, solar direct transmittance, total solar energy transmittance, ultraviolet transmittance and related glazing factors”. To measure light transmission at a particular wavelength, any suitable equipment complying with the ISO 9050:2003 may be used, such as a UV-Vis Spectrophotometer (e.g., U4000, Hitachi High-Tech Science). The light transmission of an interlayer 120, 122 refers to the light transmission through the interlayer 120, 122 when laminated in a glazing.

After the photopolymer film 130 is formed, including recordation and bleaching, the film 130 is no longer responsive to a reactive light. It may be preferable to protect the interlayer 122 and the laminated film 130 from long term exposure to ultraviolet light; however, ultraviolet light absorbers may not be added to the laminated interlayer 122 after lamination. Where the interlayer excluding ultraviolet light absorbers is an inner interlayer 122 facing a vehicle interior, light may reach the inner interlayer 122 from other openings in the vehicle, such as a side window, sunroof, and back window. Thus, it may be preferable to protect the interlayer 122 and the laminated holographic film 130 from ultraviolet light radiation after the laminated photopolymer film 130 has been bleached. Protection may be provided by an ultraviolet light shielding coating 140 that may be applied on a glass sheet surface facing a vehicle interior.

A suitable coating 140 may preferably include a base and light shielding additives. A coating base may be any suitable material and preferably has sufficient durability to be applied to a glazing surface. In particular embodiments, the coating base may be a silicon dioxide-based material, which may optionally be sintered from a binder containing tetra-alkoxysilane, tri-alkoxysilane, or combinations thereof. In some embodiments, the coating may further include polymer resin, such as epoxy, silicone, vinyl ester, polyvinyl butyral, polyvinyl alcohol, urethane, and/or combinations thereof. In some example coatings, ultraviolet light shielding additives may be provided in an amount as to be 5 to 20% by mass of the coating 140. It may be preferable that a coating base provide moisture protection for ultraviolet light shielding materials dissolved therein. Ultraviolet light shielding coatings suitable for use in the present disclosure are described in the art, for example, in Japanese Patent No. 6273980. The coating 140 may be applied to a glazing surface after lamination, recordation, and bleaching. Particularly, the coating 140 may be applied to a surface of the first or second glass sheet. The coating 140 may be applied by any suitable means, including spin, flow, or spray applications known in the art. The coating 140 may then be fired or cured by suitable means, such as heat treatment. In a certain embodiment, the coating 140 may be cured based on a sol-gel process. Preferably the curing or firing process does not interfere with the film 130 laminated in the glazing. For example, firing the coating may include heating the coated glazing to a temperature of from 100° C. to 160° C. In certain embodiments, the coating 140 base may be clear or colored. The laminated film 130 may be positioned between an interlayer 120 and a coating 140, each having ultraviolet light shielding capabilities.

Particularly, the ultraviolet light shielding function in the coating 140 may include light absorption such that ultraviolet light is absorbed by the coating 140. The ultraviolet light absorbing additives in the coating 140 may be a suitable material to dissolve in the coating base. The ultraviolet light absorbing coating 140 may contain, without limitations, triazine-based, benzophenone-based, or benzotriazole-based absorption materials and/or combinations thereof. In some embodiments, inorganic ultraviolet light absorbing additives (such as zinc oxide, titanium oxide, or cerium oxide particles), may be dispersed in the coating base. In some further embodiments, an ultraviolet light shielding coating may include other functional additives such as infrared light shielding materials including, without limitation, indium tin oxide particles or cesium tungsten oxide particles. Triazine-based absorption materials may include, for example, 6-(4-hydroxy-3,5-di-t-butylanilino)-2,4-bis-octylthio-1,3, 5-triazine, 6-(4-hydroxy-3,5-dimethylanilino)-2,4-bis-octylthio-1,3,5-triazine, 6-(4-hydroxy-3-methyl-5-t-butylanilino)-2,4-bis-octylthio-1,3,5-triazine, and 2-octylthio-4,6-bis-(3,5-di-t-butyl-4-oxyanilino)-1,3,5-triazine. Benzophenone-based absorption materials may include, for example, 2-hydroxy-4-methoxybenzophenone, 2,2′-dihydroxy-4-methoxybenzophenone, 2-hydroxy-4-methoxy-2-carboxybenzophenone, and 2-hydroxy-4-n-octoxybenzophenone. Benzotriazole-based absorption materials may include, for example, 2-(5-chloro-2-benzotriazolyl)-6-tert-butyl-p-cresol, 2-(5-methyl-2-hydroxyphenyl)benzotriazole, 2-[2-hydroxy-3,5-bis(α,α′-dimethylbenzyl)phenyl]-2H-benzotriazole, 2-(3,5-di-t-butyl-2-hydroxyphenyl)benzotriazole, 2-(3-t-butyl-5-methyl-2-hydroxyphenyl)-5-chlorobenzotriazole, 2-(3,5-di-t-butyl-5-methyl-2-hydroxyphenyl)-5-chlorobenzotriazole, 2-(3,5-di-t-amyl-2-hydroxyphenyl)benzotriazole, and 242′-hydroxy-5′-t-octylphenyl)benzotriazole.

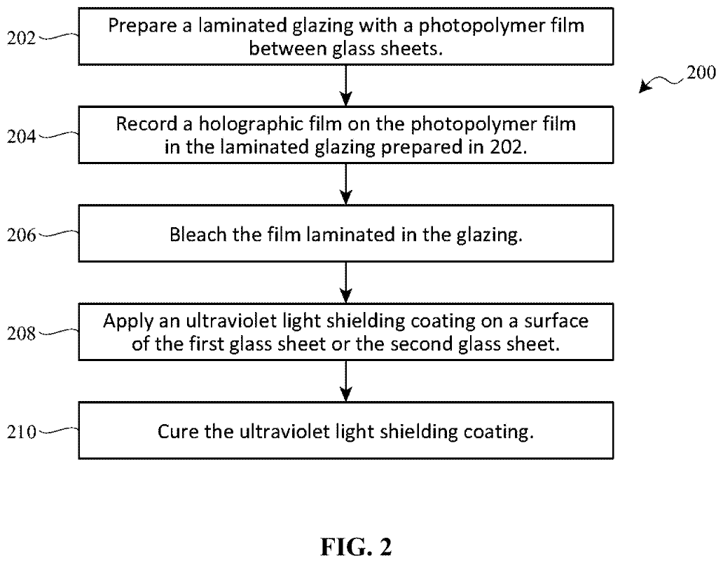

An example method 200 of preparing a glazing with an ultraviolet light shielding coating is shown in FIG. 2. According to the method 200, a laminated glazing may be prepared with a photopolymer film laminated therein in step 202. A holographic film may then be recorded on the photopolymer film according to step 204, followed by bleaching the film in step 206. Step 208 may include applying an ultraviolet light shielding coating on a surface of the first glass sheet or the second glass sheet, followed by step 210: curing the coating.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A laminated glazing, comprising:
a first glass sheet:
a first interlayer;
a holographic film;
a second interlayer, wherein the second interlayer has a light transmission of at least 70% at a light wavelength in the range of 250 nm to 400 nm;
a second glass sheet; and
an ultraviolet light absorbing coating.

2. The laminated glazing according to claim 1, wherein the ultraviolet light absorbing coating is on the second glass sheet.

3. The laminated glazing according to claim 1, wherein the ultraviolet light absorbing coating is silicon dioxide-based.

4. The laminated glazing according to claim 1, wherein the ultraviolet light absorbing coating comprises ultraviolet light absorbing particles.

5. The laminated glazing according to claim 1, wherein the second interlayer excludes ultraviolet light absorbing additives.

6. The laminated glazing according to claim 1, wherein the second interlayer has light transmission of at least 80% at a light wavelength in a range of 250 nm to 400 nm.

7. The laminated glazing according to claim 6, wherein the second interlayer has light transmission of at least 90% at a light wavelength in a range of 250 nm to 400 nm.

8. The laminated glazing according to claim 1, wherein the holographic film is formed by radiation of a reactive light through a master holographic film, followed by a bleaching light, on a photopolymer film.

9. The laminated glazing according to claim 8, wherein the reactive light is an ultraviolet light.

10. The laminated glazing according to claim 8, wherein the bleaching light is an ultraviolet light.

11. A method of preparing a laminated glazing, comprising:
laminating a first glass sheet, a first interlayer, a photopolymer film, a second interlayer, and a second glass sheet;
recording the photopolymer film to provide a holographic film;
bleaching the holographic film with a bleaching light; and
applying an ultraviolet light absorbing coating to a surface of the first glass sheet or the second glass sheet.

12. The method according to claim 11, wherein recording the holographic film comprises applying a reactive light to the photopolymer film through a master holographic film assembly to replicate a holographic pattern to the photopolymer film.

13. The method according to claim 12, wherein replicating the holographic film comprises applying the reactive light to the photopolymer film through the second glass sheet.

14. The method according to claim 13, wherein the second interlayer has a light transmission of at least 90% at a wavelength in a range of 250 nm to 400 nm.

15. The method according to claim 14, wherein the second interlayer excludes ultraviolet light absorbing additives.

16. The method according to claim 14, wherein the first interlayer includes ultraviolet light absorbing additives.

17. The method according to claim 13, wherein the ultraviolet coating is applied to the second glass sheet.

18. The method according to claim 11, further comprising curing the ultraviolet light absorbing coating on the glazing.

19. The method according to claim 11, wherein the bleaching light includes light having a wavelength in a range of 250 nm to 400 nm.

20. The method according to claim 12, wherein the reactive light includes light having a wavelength in a range of 250 nm to 400 nm.
